(19) United States
(12) Patent Application Publication
(10) Pub. No.: US 2014/0306544 A1
(43) Pub. Date: Oct. 16, 2014

(54) PHOTOVOLTAIC SYSTEM WITH BIASING AT THE INVERTER

(71) Applicants: Jochen Hantschel, Dettingen a.d.Erms (DE); Steffen Notz, Bad Urach (DE)

(72) Inventors: Jochen Hantschel, Dettingen a.d.Erms (DE); Steffen Notz, Bad Urach (DE)

(73) Assignee: REFUSOL GMBH, Metzingen (DE)

(21) Appl. No.: 14/233,171

(22) PCT Filed: Jul. 18, 2012
(86) PCT No.: PCT/EP2012/064045

§ 371 Date: Apr. 24, 2014

(30) Foreign Application Priority Data
Jul. 19, 2011 (DE) 10 2011 051 954.8

(51) Int. Cl. H02M 7/537

(52) U.S. Cl. CPC H02M 7/537
USPC 307/82; 363/71

(57) ABSTRACT

A photovoltaic system for converting a DC voltage from a photovoltaic generator into an AC voltage, includes a transformerless power inverter which comprises high-frequency-clocked switching units, the DC voltage input of which is connected to the photovoltaic generator, and the AC voltage output of which is connected to a series circuit consisting of a bias generating device and an inductive HF decoupling device. The bias generating device is used to apply a bias potential to the AC voltage output of the power inverter, said bias potential also indirectly influencing the voltage potential at the DC voltage input of the power inverter. The inductive HF decoupling device is used for the HF decoupling of the AC voltage side from the DC voltage side of the power inverter in order to prevent capacitive discharge currents to the photovoltaic generator due to the use of the bias generating device.

The present invention relates to an apparatus for a photovoltaic system having a bias generation device for generating a bias at an inverter of the photovoltaic system.

Photovoltaic systems having a photovoltaic generator which generates electrical energy from solar energy, an inverter which converts a DC voltage provided by the photovoltaic generator into AC voltage and feeds this AC voltage into an energy supply grid, for example, are used increasingly. A photovoltaic system can have a large number of photovoltaic cells and/or inverters. Individual photovoltaic cells are usually connected in series to form a module, and one or more modules are connected in series to form so-called strings, which form the photovoltaic generator. This photovoltaic generator then delivers a high DC voltage of up to over 1000 volts to the inverter, which converts this high DC voltage into an AC voltage and an alternating current with an amplitude, phase and frequency which conform to the grid to be fed. For this purpose, single-phase or three-phase inverters with and without transformers are known.

Transformer-less inverters which convert power into the AC grid voltage without any galvanic isolation of the photovoltaic generator are preferred because they are designed smaller and less expensive and have markedly improved efficiency in comparison with transformer-based inverters. However, owing to the lack of galvanic isolation between the DC voltage side and the AC voltage side, it is not possible to establish a defined potential in relation to the ground, for example by means of grounding, at the positive or negative pole of the photovoltaic modules. A defined potential with respect to the ground potential at the photovoltaic generator may be necessary, however, in order to meet, for example, legal requirements in respect of upper limits for potential differences at system parts, in order to enable capturing of insulation faults, in order to avoid TCO corrosion or an impairment to the efficiency at specific photovoltaic modules, etc.

It has been established, for example, that irreparable damage as a result of so-called “TCO corrosion”, i.e. corrosion at a transparent, electrically conductive coating, the so-called TCO (transparent conductive oxide) layer, can arise at specific photovoltaic modules, in particular at thin-layer modules. The TCO layer corrodes under the influence of moisture and heat, which can result in failure of individual regions of photovoltaic modules and ultimately in a loss of performance of the entire module. It is known that the TCO corrosion forms more rapidly and to a greater extent if the photovoltaic cells have negative electrical potentials with respect to ground.

Conversely, in the case of crystalline photovoltaic modules with contact to the photovoltaic cells being made on the reverse, losses in efficiency have been observed if the photovoltaic cells have a positive voltage potential with respect to ground during operation. It would appear that the losses in efficiency can be attributed to a polarization effect owing to a static charge which is built up on the surface of the photovoltaic cell, and these losses in efficiency can be reduced if the photovoltaic cells are kept below ground potential, i.e. at a more negative potential than ground potential.

For the abovementioned reasons, the manufacturers of this kind of photovoltaic modules recommend the use of inverters with galvanically isolating transformers which allow a defined potential with respect to the ground potential to be applied at the photovoltaic generator. At the same time, depending on the type of photovoltaic generator used, its negative or positive pole should be grounded. In this way, it is possible to avoid the possibility of the photovoltaic cells of thin-layer modules or crystalline modules with which contact is made on the reverse taking on a negative or positive voltage with respect to ground. However, this is obtained by the use of a transformer-based inverter which is designed heavier and larger, increases the production and installation costs and reduces the efficiency.

WO 2008/154918 A1 proposes, in connection with thin-layer modules, a transformer-less inverter unit which has a step-up converter connected between the negative photovoltaic generator pole and the negative input of the inverter. By virtue of the use of the step-up converter, the characteristic of the photovoltaic modules can be influenced in such a way that negative electrical potentials with respect to ground, and therefore possible damage as a result of corrosion, are reduced. The step-up converter likewise causes higher manufacturing and operating costs and losses in efficiency, however.

WO 2010/078669 A1 describes a photovoltaic power station with a photovoltaic generator and a transformer-less inverter and proposes providing a potential shift device at the AC voltage output of the inverter, which potential shift device superimposes a voltage component on the AC voltage, by means of which voltage component the potential at the DC voltage input side of the inverter can also be raised or lowered. The superimposed voltage of the potential shift device can be DC voltage and/or AC voltage. The superimposed voltage can also be controlled by capturing measured values at the input of the inverter.

Similarly, WO 2010/051812 A1 also proposes providing an offset voltage source at the AC voltage output of a transformer-less photovoltaic inverter, by means of which offset voltage source the DC voltage potential at the input side of the inverter can also be controlled indirectly in order to make all of the potentials at the connections of the photovoltaic modules all positive or all negative with respect to ground, depending on the module type. The offset voltage can be controlled, programmed or disconnected. By monitoring the current flowing out of the offset voltage source, insulation faults can be captured.

By virtue of the proposed superimposition of a bias (shift voltage, offset voltage) at the AC voltage output of a transformer-less inverter, it is possible to ensure that the potential at the photovoltaic modules never exceeds or falls below a specific voltage value, depending on requirements. Therefore, the abovementioned TCO corrosion and polarization effects can be avoided. However, a transformer which transforms the output voltage of the inverter to a desired voltage for transmission via high-voltage lines or for feeding to a grid is required at the output of the inverter. The bias superimposed on the AC voltage is then negligible owing to the subsequent transformation.

The potential shift device or offset voltage source of the previously known photovoltaic systems is connected between ground and the star point or neutral connection of the output-side transformer. As a result, the potential of the star point or neutral point is no longer free, but is fixed or is clamped. This clamping of the potential of the star point or neutral point can result in discharge currents, however. Conventional inverters for photovoltaic systems have switch elements which are connected to form full-bridges or half-bridges and which are clocked in accordance with a preset clock pattern and modulation method at a high frequency of up to approximately 20 kHz. As a result of this high-frequency clocking of the switch elements, in the case of a three-phase inverter configuration, the voltage potential at the AC voltage connections and in particular also at the star point or neutral point jumps with a relatively high amplitude and high frequency, which corresponds to three times the clock frequency. If the potential of the star point or neutral point is now fixed, parasitic capacitances of a photovoltaic generator which are relatively high, in any case much higher than corresponding parasitic capacitances at the output side of the inverter, need to be subjected to charge reversal, which is associated with high displacement currents at the photovoltaic generator and therefore high discharge currents at the DC voltage side of the inverter.

The capacitive discharge currents are wattless currents and therefore loss-free per se. However, under certain circumstances, when they flow away, for example, via the PE conductor, said discharge currents can represent a hazard potential because, in the event of interruption of the PE conductor and at the same time touching contact being made with the photovoltaic housing, a life-threatening shock current could flow through the person making the touching contact. This has to be avoided.

In addition, it is difficult to differentiate between a discharge current and a fault current which flows in the event of contact between a live line and a grounded person as a result of a fault, for example damaged insulation. In order to ensure sufficient protection against personal injury, electrical appliances as a precaution need to be isolated from the grid in the event of a certain fault current. The inverter can in this case be isolated automatically from the grid when the discharge current becomes too high. This can disrupt operation and reduce the generation power.

In addition, discharge currents, when flowing as circulating currents via the inverter and the bias source, can damage said inverter and bias source. Furthermore, discharge currents make the capturing of insulation faults difficult.

Against this background, one objective of the invention consists in eliminating the above shortcomings and to propose in particular measures or means which can avoid or largely reduce such discharge currents. In particular, an objective of the invention consists in providing an apparatus for converting an electrical DC voltage into an AC voltage with a transformer-less inverter, which apparatus is suitable for operation with thin-layer photovoltaic modules as well as crystalline modules with contact-making on the reverse or other modules which require a defined maximum or minimum potential, but which avoids or at least largely reduces discharge currents and disadvantages associated therewith. This is preferably performed with simple means which preferably can also be retrofitted in existing systems.

A further objective of the present invention consists in providing such an apparatus which also enables safe identification of insulation faults, in particular also creeping insulation faults, during operation.

This objective is achieved by the apparatus as claimed in claim 1 or the additional module as claimed in claims 16.

In accordance with a first aspect of the invention, an apparatus for converting an input-side electrical DC voltage of a photovoltaic generator into an output-side AC voltage is provided. The apparatus according to the invention has an inverter which has a DC voltage input for connection of a photovoltaic generator and an AC voltage output. The inverter is transformer-less and is therefore capable of converting the input-side DC voltage into the output-side AC voltage with a high degree of efficiency.

The apparatus according to the invention also has a bias generation device for applying a bias potential to the AC voltage output of the inverter, as a result of which at the same time indirectly also the voltage potential at the DC voltage input of the inverter is influenced. For example, the bias generation device makes it possible, by applying a positive or negative bias potential at the AC voltage output of the inverter, to raise or lower the voltage potential at the DC voltage input of the inverter in such a way that the potential at the negative pole of a connected photovoltaic generator does not fall below a predetermined minimum value, for example zero volt, with respect to protective ground (protective earth=PE) or the positive pole does not exceed a predetermined maximum value, for example zero volt, with respect to PE. This ensures that all of the photovoltaic cells are kept either above (in the case of more positive potentials) or below (in the case of more negative potentials) the ground potential, depending on requirements, with the result that damaging TCO corrosion of thin-layer modules or polarization effects in the case of crystalline modules with which contact is made on the reverse can be avoided. As a result, the basis for a high degree of efficiency in the conversion of solar energy to electrical energy is provided.

The invention is further characterized by an inductive radiofrequency (RF) decoupling device, which is arranged and designed for RF-decoupling the AC voltage side from the DC voltage side of the inverter. The inductive RF decoupling device provides this radiofrequency decoupling by virtue of enabling sudden changes in potential at the AC voltage side of the inverter given a constant mean value for the potential corresponding to the value of the bias preset by the bias generation device. As a result, the inductive RF decoupling device according to the invention prevents feedback of the sudden changes in potential onto the DC voltage side of the inverter and as a result onto the photovoltaic generator and displacement currents associated with said feedback, for the charge reversal of parasitic capacitances of the photovoltaic generator. In other words, the inductive RF decoupling device blocks or damps any discharge currents and prevents the possibility of said discharge currents being produced at the photovoltaic generator and flowing as circulating currents via the inverter and the bias generation device and damaging said inverter and bias generation device.

The apparatus according to the invention furthermore preferably has a photovoltaic generator with at least one photovoltaic module in order to form a photovoltaic system. By virtue of the bias generation device, thin-layer modules or crystalline modules with contact-making on the reverse can also be used as photovoltaic modules in a protective and effective manner.

The inverter according to the invention is preferably set up in a three-phase configuration with three AC voltage output connections which are each assigned to one of the three phases of the output voltage. Naturally, the inverter can also contain three separate inverter units for the individual phases, and these units can be coupled to the same or else to separate photovoltaic generators.

The inverter can be set up in the full-bridge or half-bridge configuration of switches with high-frequency clocking, as is generally known from the prior art. The half-bridge configuration is preferred because it reduces the number of switch elements and associated costs, switching losses and control complexity involved.

Preferably, the inverter according to the invention has a balancing circuit, which serves the purpose of setting the voltage potentials at the input connections of the inverter to be substantially symmetrical with respect to the bias potential provided by the bias generation device. In a preferred embodiment of the invention, the inverter has, for this purpose, a DC voltage intermediate circuit having two energy buffer stores, which are connected in series with one another between the DC voltage input connections and are formed, for example, by equally-dimensioned capacitors. The node between the energy buffer stores is electrically connected to a neutral conductor, to which the bias generation device is also connected. The preset bias potential is therefore on average also present at the node between the energy buffer stores. The balancing circuit could also be implemented as a voltage divider on the basis of resistors, although these are subject to losses, or by inductances. In any case, the balancing makes it possible for the potentials at the positive and negative input connections of the inverter to be symmetrical with respect to the neutral conductor, with the result that only half the photovoltaic generator voltage is always sufficient as bias in order to keep the potentials for all PV modules at either a non-negative or a non-positive potential with respect to the ground potential. This simplifies any control or regulation of the bias of the bias generation device.

The photovoltaic system according to the invention preferably also has a grid transformer, which is connected to the AC voltage output of the inverter and matches the inverter output voltage to grid characteristics of a grid to be fed. For example, the inverter output voltage is transformed to the AC voltage of a public electricity supply grid or to a high voltage which is suitable for transmission via high-voltage lines. Advantageously, the output transformer enables galvanic isolation between the AC voltage output side of the inverter and the grid connected thereto. As a result, the bias potential preset by the bias generation device at the output of the inverter does not impair the grid voltage.

Moreover, the transformer preferably has a primary side which is connected to the AC voltage output of the inverter, a secondary side for connection to the grid and a neutral connection at the primary side, which neutral connection is preferably connected to a neutral conductor. Particularly preferably, the neutral conductor is also connected to the center point between the capacitors or energy stores in the DC voltage intermediate circuit, is passed through from the DC voltage side to the AC voltage side of the inverter and is also connected to the bias generation device. This simplifies the design and control of the inverter and of the bias generation device.

The grid transformer is preferably a three-phase transformer which has three outer conductor phases, which are connected to a three-phase inverter or to separate single-phase inverters. The other ends are then connected to one another in the star circuit at the star point, wherein the star point preferably forms the neutral connection which is electrically connected to the bias generation device and to the node between the intermediate circuit capacitors via the neutral conductor. The bias device can also be connected to the outer conductor phases of the primary side of the grid transformer or to the AC voltage output lines of the inverter, however.

The bias generation device has a constant voltage source, which is connected between ground and the AC voltage output of the inverter. The constant voltage source can be variable, with the result that the magnitude and polarity of the bias delivered by the constant voltage source can be controlled or regulated during operation.

The inductive RF decoupling device according to the invention is provided for RF-decoupling the photovoltaic generator from the AC voltage input side of the inverter. In a particularly preferred embodiment which is easy to implement, the inductive RF decoupling device is formed by a single inductance, for example an inductor, coil or the like, which is connected in series with the bias generation device between ground and the neutral conductor. The neutral conductor is preferably passed through from the DC voltage side to the AC voltage side of the inverter and connected to the star point of the grid transformer, which is connected to the output of the inverter, as explained above, and preferably also to the PE conductor of the photovoltaic system.

The inductance acts as an RF impedance for isolating or damping high-frequency discharge currents. It enables the sudden changes in potential at the star point and prevents these from being fed back to the DC voltage side. At the same time, a mean potential corresponding to the bias preset by the bias generation device is maintained at the star point, which mean potential also determines the (mean) potential at the DC voltage side of the inverter or at the photovoltaic generator.

In a modified embodiment of the inductive RF decoupling device according to the invention, said RF decoupling device has a number of inductances which corresponds to the number of phases of the inverter output voltage, which inductances are each connected to an AC voltage output connection of the inverter and secondly are connected to one another at a common node. The bias generation device is then connected to the node. Advantageously, this embodiment of the RF decoupling device according to the invention can be used in grid transformers both with a star circuit and a delta circuit because the common node of the inductances forms a virtual star point for the connection of a bias generation device. Moreover, the plurality of inductances are effective for isolating or damping high-frequency discharge currents in the same way as the individual inductance of the above-explained embodiment.

In a preferred embodiment of the invention, the apparatus also has a sensor device for capturing measurement parameters, including the DC voltage potentials at the input of the inverter and a current in the branch of the bias generation device, and a control device, which control device is designed to, on the basis of the measurement parameters, control the operation of the apparatus, identify possible fault states and respond to these fault states. Preferably, the control device is also designed to adjust the value of the bias applied by the bias generation device on the basis of the captured measurement parameters variably, depending on requirements. In particular, it can be capable of matching the magnitude of the bias to the voltage of the photovoltaic generator in a suitable manner, said voltage varying depending on the time of day, incoming radiation conditions, temperature and other weather and environment conditions. For example, for no-load operation, a relatively high bias potential corresponding to the relatively high generator voltage during no-load operation can be provided, while during operation, the voltage potential can be reduced appropriately in order to avoid high insulation loading and losses, as would be associated with a fixed bias value.

It goes without saying that the control device can be designed for controlling or regulating the inverter, on the one hand, and the bias generation device, on the other hand, as desired either by means of a common integral control unit or by means of different, distributed control units and can be implemented using software and/or hardware.

The control device can have logic for identifying ground faults or insulation faults on measurement parameters captured by the sensor device. In a particularly preferred embodiment, this logic is also designed for identifying a creeping insulation fault, as follows: first, the logic presets a first value for the bias potential of the bias generation device, and the magnitude of the DC voltage potentials at the input of the inverter and the current in the branch of the bias generation device are measured. Then, the logic modifies actively the potential of the bias of the bias generation device and presets a second value for this. The sensor device thereupon captures the magnitude of the DC voltage potentials at the input of the inverter and the current in the branch of the bias generation device for the second preset bias potential value. The logic then determines the insulation resistances at the positive and negative DC voltage input connections of the inverter from the measured values and preset values for the voltage potentials and the currents. By comparing the determined insulation resistances with reference values, the logic can capture the onset of an insulation fault in good time. Advantageously, this identification of a creeping insulation fault can also take place during operation, for example on a periodic basis.

In accordance with a further aspect of the invention, an additional module for an apparatus for converting an electrical DC voltage of a photovoltaic generator applied at the input side of the apparatus into an output-side AC voltage is provided, wherein the apparatus has at least one transformer-less inverter with a DC voltage input for connecting a photovoltaic generator and an AC voltage output. The additional module according to the invention has a connection means for connection to the AC voltage output of the inverter, a bias generation device for applying a bias potential to the connection means, as a result of which, during operation, the voltage potential at the DC voltage input of the inverter is also influenced when the connection means of the additional module is connected to the AC voltage output of the inverter, and an inductive RF decoupling device, which is designed, during operation, for RF-decoupling the AC voltage side from the DC voltage side of the inverter when the connection means of the additional module is connected to the AC voltage output of the inverter.

The additional module can therefore be installed retrospectively as a retrofittable structural unit in an existing photovoltaic system. In principle, it can be connected to any desired point between the inverter output and a grid transformer, accommodated in the housing of the inverter or the grid transformer or integrated in the inverter or grid transformer. Moreover, the additional module, in particular the RF decoupling device, bias generation device and control device thereof, can be designed in the manner described above in connection with the conversion device according to the invention. In order to avoid repetition, reference is made to the above description relating to possible embodiments and the advantages thereof.

The invention makes it possible to operate transformer-less inverters on photovoltaic generators which are constructed from thin-layer modules or crystalline modules with contact-making of the cells on the reverse, so as to avoid damage and reductions in efficiency owing to TCO corrosion and polarization effects and so as to avoid high discharge currents at the photovoltaic generator which can cause damage to the components of the photovoltaic system.

Further details of advantageous embodiments of the invention are the subject matter of the drawing, the description or the dependent claims. Embodiments of the invention are illustrated in the drawing, in which:

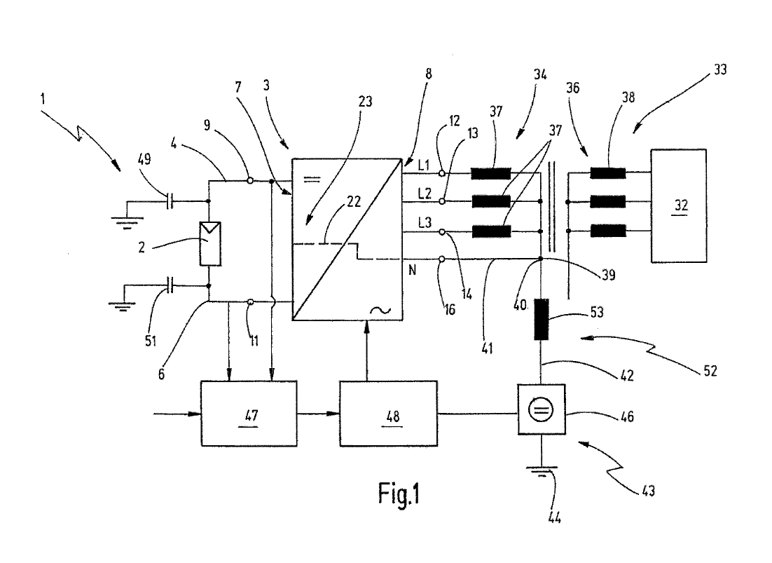

FIG. 1 shows a photovoltaic system according to the invention for converting a DC voltage of a photovoltaic generator into an AC voltage for feeding into a grid with a bias device and an RF decoupling device in accordance with a first embodiment, in a very schematized illustration;

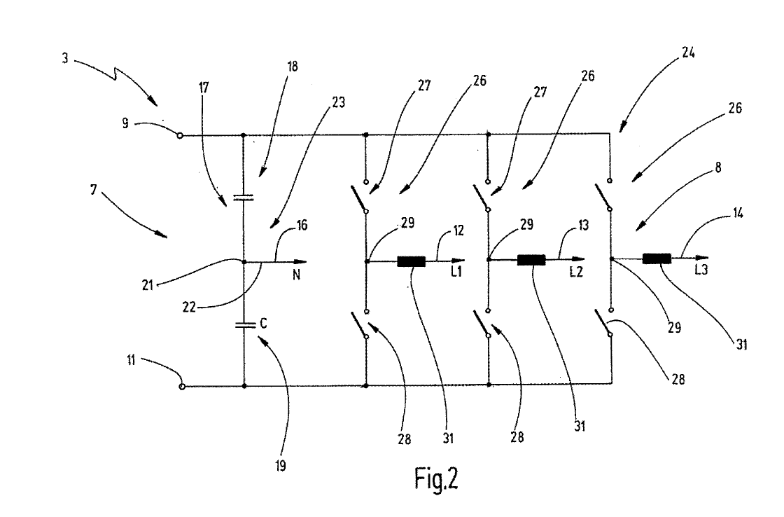

FIG. 2 shows an embodiment of an inverter for use in the photovoltaic system according to claim 1, in a simplified illustration;

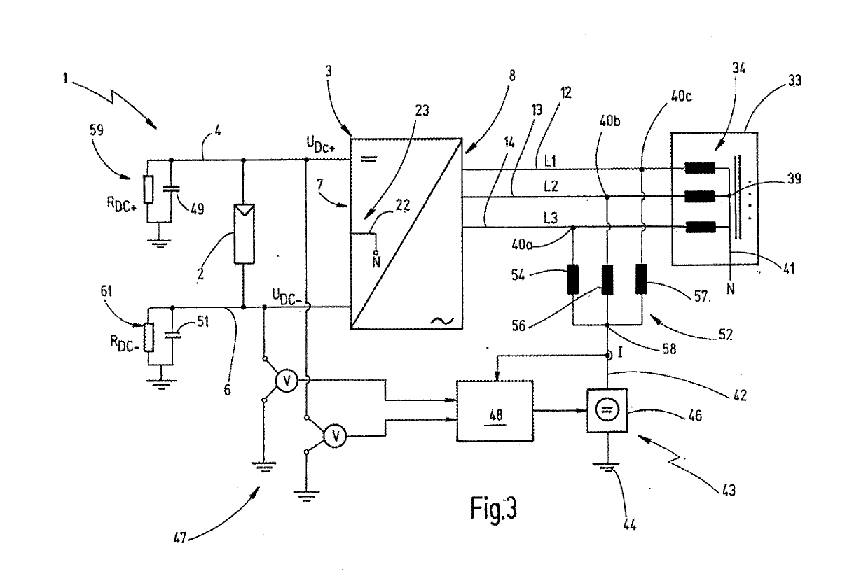

FIG. 3 shows a photovoltaic system having a further embodiment of an RF decoupling device according to the invention, in a very schematized illustration; and

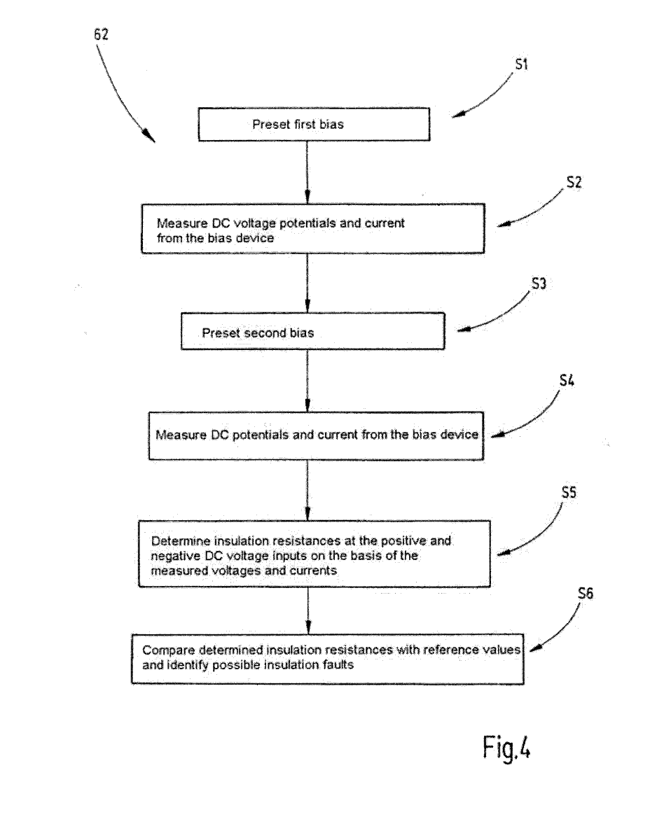

FIG. 4 shows a block diagram of a method according to the invention for identifying insulation faults.

FIG. 1 shows, in very schematized form, a photovoltaic system 1, which forms an apparatus according to the invention for converting an electrical DC voltage of a photovoltaic generator 2 applied at the input side of the apparatus into an output-side AC voltage. The photovoltaic system 1 has a photovoltaic generator 2 and a three-phase inverter 3. The photovoltaic generator 2 has one or more PV modules, which are not illustrated in detail here and which can be formed by any desired crystalline modules or thin-layer modules, as are known from the art, and which are connected in series with one another in order to generate a single DC output voltage at the output poles 4, 6 of the photovoltaic generator 2.

The inverter 3 is designed to convert the DC voltage provided by the photovoltaic generator 2 at its input 7 into a three-phase AC voltage at its output 8. For this, the inverter 3 has the input 7 with a positive and a negative input connection 9, 11, which are each connected to the positive and negative pole 4, 6, respectively, of the photovoltaic generator 2, and the four-pole output 8, to which the three output connections (L1, L2, L3) 12, 13, 14, which lead the individual phases of the output-side AC voltage of the inverter 3, and a neutral output connection (N) 16 of the inverter 3 belong.

A possible embodiment of the inverter 3 is illustrated in very schematized form in FIG. 2. The inverter 3 has a DC voltage intermediate circuit 17 with two energy buffer stores 18, 19 in the form of capacitors C connected in series, which energy buffer stores 18, 19 are connected at one end in each case to the positive or negative input connection 9, 11 of the inverter 3 and are connected to one another at their other end at a node 21, which is electrically connected to the neutral output connection 16 via a line 22 passing through the inverter 3. The intermediate circuit capacitors 17, 18 and the neutral line 22 form part of a balancing circuit 23, which serves the purpose of fixing the potentials at the input connections 9, 11 of the converter 3 symmetrically with respect to the potential at the neutral line 22.

The inverter 3 also has a switch arrangement 24, which is connected to the input connections 9, 11 in parallel with the intermediate circuit capacitors 18, 19. The switch arrangement 24 is formed by a parallel circuit comprising three substantially identical half-bridges 26, which each have two switch units 27, 28, which are connected in series with one another and which are switchable at high frequencies of up to 100 kHz. Although the switch units 27, 28 are in this case merely illustrated symbolically, preferably low-loss IGBT (insulated gate bipolar transistor) or MOS field-effect transistor switches are used. Conventionally, in each case one (not illustrated) freewheeling diode with forward directions in opposition is connected in parallel with each switch unit 27, 28. The node 29 between the switch units 27, 28 in each half-bridge 26 is passed out to the respective AC voltage output connection 12, 13 or 14 via a connecting line 31, which contains a storage inductor 32. The switch units 27, 28 of the respective half-bridges 26 are clocked in such a way that a three-phase alternating current for feeding into a grid 32 is generated at the output connections 12, 13, 14, which alternating current preferably has three output currents which are substantially identical in magnitude but are each phase-shifted with respect to one another through 120°.

Again with reference to FIG. 1, the output 8 of the inverter 3 is connected to a grid 32, for example a public electricity supply grid or a high-voltage transmission grid, via an output-side transformer 33, which ensures galvanic isolation between the inverter output 8 and the grid 32 and matching of the magnitude of the output voltages and currents delivered by the inverter 3 to the magnitudes required by the grid 32.

The transformer 33 is in this case conventionally in the form of a three-phase transformer with a primary side 34 and a secondary side 36, which each have three star-connected primary windings 37 at the primary side 34 and three star-connected secondary windings 38 at the secondary side 36. The central node or star point of the primary windings 37 forms the neutral connection 39 of the transformer 33. As illustrated, the neutral connection 39 is connected to the neutral output connection 16 of the inverter 3 via a neutral conductor 41 and also connected to the node 21 between the intermediate circuit capacitors 17, 18 via the inverter-internal neutral line 22.

As can further be seen from FIG. 1, the neutral connection 39 of the transformer 33 is also connected to a first connection means 40 of a branch 42, in which a bias generation device 43 is arranged which is connected with another connection means to ground 44. The bias generation device 43 serves the purpose of applying a defined bias potential during operation to the connection means 40 or the neutral connection 39 of the transformer and therefore the neutral output connection 16 of the inverter 3, which defined bias potential is then coupled to the node 21 in the DC voltage intermediate circuit 17 via the neutral conductors 41, 22. For this, the bias generation device 43 has a constant voltage source 46, which delivers a constant voltage with a variably adjustable magnitude at its output connection connected to the neutral connection 39.

In order to adjust the bias of the bias generation device 43 and to control the operation of the inverter depending on instantaneous operational and environmental conditions, a control device 47 is provided, which is only illustrated in schematized form here in the form of a block 47. The control device 47 is coupled to a sensor device 48, which captures different measurement parameters at the photovoltaic system 1 and delivers values characteristic of these measurement parameters to the control device 47. The captured measurement parameters include, inter alia, the DC voltage potentials U_{DC+}, U_{DC-} at the positive and negative input connections 9, 11 of the inverter 3, as indicated in FIG. 1, and, for example, the AC voltages and/or alternating currents at the output connections 12, 13, 14 (not illustrated in any more detail here).

The photovoltaic system 1 described hitherto is known per se and functions as follows: the photovoltaic generator 2 converts the radiation energy received from the sun into electrical energy and thus generates a DC voltage at its poles 4, 6. The voltage delivered by the photovoltaic generator 2 is dependent on the incoming radiation conditions, the temperature, the humidity in the environment of the photovoltaic generator 2 and other factors and is generally approximately 600 to 1000 volts during operation. The inverter 3 converts the DC voltage at its input 7 into a three-phase AC voltage at its output 8, from where the three-phase AC voltage is fed into the grid 32 via the transformer 33. The inverter 3 is driven by the control device 47 appropriately corresponding to the operational values measured by the sensor device 48 in order to deliver the AC voltages and alternating currents suitable for the feed at its output. The transformer 33 matches these voltages and currents correspondingly to the requirements of the grid 32.

During operation, the bias generation device 43 applies a bias to the neutral connection 39 of the transformer 33 and thus effects a shift in the DC voltage potential at the primary side 34 of the transformer 33 and therefore also at the output 8, in particular the neutral output connection 16 of the inverter 3 with respect to the ground potential, with this shift amounting to the bias. As a result of the balancing circuit 23, including the neutral conductors 22, 41, the potentials at the positive and negative input connections 9, 11 are symmetrical with respect to one another in respect of the bias, and therefore amount to approximately zero volt at one of the connections 9, 11 and approximately twice the bias at the other connection 9, 11. By selecting a suitable magnitude and polarity for the bias of the bias generation device 43 with respect to the ground potential, it is thus possible to ensure that the potentials with respect to ground 44 are either non-negative or non-positive, for example, for all photovoltaic modules of the photovoltaic generator 2 and are always close to the ground potential.

As is known, photovoltaic modules form electrically chargeable areas which are opposite a grounded frame and therefore form parasitic capacitances which can store the charge. The parasitic capacitances of the photovoltaic modules are comparatively high and are in the region of approximately 1 μF per cable peak voltage. They are dependent on design factors, such as the materials used and the effective area for charge storage and can be considerably increased by weather-dependent factors, for example wetting with water. In any case, the parasitic capacitances of photovoltaic modules are considerably higher than those at the AC voltage side of a transformer-less converter. In FIG. 1, the parasitic capacitances of the photovoltaic generator 2 are indicated by two capacitances 49, 51, which are connected between the positive and negative poles 4, 6, respectively, of the photovoltaic generator 2 and ground.

In a conventional photovoltaic system with a three-phase inverter, in particular with a half-bridge configuration, as illustrated in FIG. 2, without the bias generation device 43 the AC voltage potential at the neutral connection or star point 39 of the transformer 33 jumps owing to the clocking of the inverter. The AC voltage potential jumps with an amplitude which is dependent on the clock pattern and modulation method used, and at a frequency which approximately corresponds to three times the clock frequency of the inverter 3. If, however, the bias generation device 43 is connected to the neutral connection 39, the potential at this connection is thus fixed. The sudden changes in potential required are now transferred via the balancing circuit 23 to the DC voltage input side of the inverter 3 and on to the photovoltaic generator 2. As a result of the sudden changes in voltage, the high parasitic capacitances of the photovoltaic generator 2 need to be constantly subjected to charge reversal, which results in high displacement currents at the photovoltaic generator 2 which are proportional to the parasitic capacitances and the voltage amplitude. The displacement currents result in discharge currents which flow away to ground and which flow in the circuit through the system, in particular through the inverter 3 and the constant voltage source 46 of the bias generation device 43, and can damage said components. In addition, such capacitive discharge currents can trigger the fault current monitoring of an inverter 3 and consequently disconnection thereof from the grid 32.

In order to avoid this, in accordance with the present invention an inductive RF decoupling device 52 is provided for RF-decoupling the AC voltage side from the DC voltage side of the inverter 3. As can be seen from FIG. 1, the inductive RF decoupling device 52 in the preferred embodiment in FIG. 1 is formed by an inductance 53 which is connected between the connection means 40 or the neutral connection 39 of the transformer 33 and the bias generation device 43. The inductance 53 has a suitable inductance value in the sense of a high RF impedance in order to sufficiently block or damp the high-frequency discharge currents to be expected during operation. The inductance 53 enables the sudden changes in the AC voltage potential at the neutral connection 39, but keeps this potential at a constant mean value, which corresponds to the bias preset by the bias generation device 43. As a result, the photovoltaic generator 2 to this extent remains “at rest” when there are no substantial sudden changes in voltage and displacement currents at said photovoltaic generator 2. By virtue of the RF decoupling device 52 according to the invention, the capacitive discharge currents which are otherwise caused by clamping of the neutral point 39 can be effectively avoided at the photovoltaic generator 2.

FIG. 3 shows a further embodiment of a photovoltaic system 1 according to the invention with a modified exemplary embodiment of an inductive RF decoupling device 52 according to the invention for decoupling the AC voltage output side of the inverter 3 from its DC voltage input side. Insofar as there is correspondence in terms of design and/or function, reference is made to the above description in connection with FIGS. 1 and 2 using the same reference symbols as a basis.

The embodiment of the apparatus 1 for converting an electrical DC voltage of a photovoltaic generator 2 applied at the input side of the apparatus 1 into an output-side AC voltage shown in FIG. 3 differs from that shown in FIG. 1 substantially only in terms of the arrangement and design of the RF decoupling device 52. Here, said RF decoupling device is not connected between the neutral connection 39 of the transformer 33 and the bias generation device 43, but between said bias generation device 43 and the input connections of the transformer 33. The unit formed from the RF decoupling device 52 and the bias generation device 43 therefore has three connections 40a, 40b and 40c for connection to respective output connections 12, 13 and 14, respectively, of the inverter 3. The RF decoupling device 52 has three inductances 54, 56 and 57, which are each connected to one of the AC voltage output connections 12, 13, 14 of the inverter 3 via the connection means 40a, 40b, 40c and secondly to a common node 58, which forms a virtual star point. This embodiment can therefore also be used when the output-side transformer 33 is not, as illustrated here, in a star circuit but is implemented in a delta circuit.

Moreover, the individual inductances 54, 56, 57 in the embodiment shown in FIG. 3, in the same way as the inductance 53 shown in FIG. 1, are effective for the inductive RF decoupling of the AC voltage output 8 from the DC voltage input 7 of the inverter 3 by virtue of the fact that, at a constant mean value of the potential at their connection means 40a, 40b, 40c and therefore the inverter output connections 12, 13, 14 corresponding to the bias of the bias generation device 43, they enable sudden changes in potential at said connection means 40a, 40b, 40c and block or damp high-frequency discharge currents towards the DC voltage side of the inverter 3 in order to minimize discharge currents at the photovoltaic generator 2.

An additional development of the apparatus 1 according to the invention is illustrated in FIG. 3. As can be seen, the sensor device 48 in this case captures the DC voltage potentials at the positive and negative input connections 9, 11 of the inverter 3 and in addition the current I in the branch 42 of the bias generation device 43. By monitoring the current I from the bias generation device 43, major insulation faults which effect ground faults can be captured, with the result that the inverter 3 can therefore be disconnected in order to avoid further damage. As a result of a ground fault, however, damage to components in the system 1 can already have occurred.

In the embodiment illustrated in FIG. 3, the control device 47 has an additional logic in order to identify creeping insulation faults, i.e. insulation faults already being produced, at the photovoltaic generator 2. This is provided by determination and monitoring of the insulation resistances R_{ISO,DC+} and R_{ISO,DC-} at the positive and negative poles 4, 6, respectively, of the photovoltaic generator 2 with respect to ground. The insulation resistances R_{ISO,DC+}, R_{ISO,DC-} are indicated as resistances 59, 61, in each case in a parallel circuit with the associated parasitic capacitance 49, 51 of the photovoltaic generator 2, in FIG. 3.

The logic 62 according to the invention of the control device 47 for identifying creeping insulation faults will be explained in connection with the flow chart shown in FIG. 4. As illustrated in FIG. 4, the control device 47 first presets a first bias of the bias generation device 43 (step S1).

The sensor device 48 thereupon captures the DC voltage potentials U_{DC+}, U_{DC-} at the positive and negative input connections 9, 11 of the inverter 3 and the magnitude of the current I from the bias generation device 43 and indicates this magnitude to the control device 47 (step S2).

The operation is repeated for a second preset voltage. The control device 47 establishes a second bias at the bias generation device 43, which differs from the first bias (step S3), and receives measured values for the DC voltage potentials U_{DC+}, U_{DC-} and the current I in the branch 42 of the bias generation device 32 from the sensor device 48 (step S4).

Then or already in parallel with the abovementioned steps, the control device 47 determines the insulation resistances R_{ISO,DC+}, R_{ISO, DC-} from the measured magnitudes (step S5). When, for example, the voltages U1, U2 are the preset biases of the bias generation device 43, I_{U1}, U_{DC+,U1}, U_{DC-,U1} and I_{U2}, U_{DC+,U2}, U_{DC-,U2} are the measured currents or DC voltage potentials for the first and second preset bias, the following equations can be cited in the first approximation for the currents I_{U1}, I_{U2}:

I_{U1}=U_{DC+,U1}/R_{ISO,DC+}+U_{DC-,U1}/R_{ISO,DC-}

I_{U2}=U_{DC+,U2}/R_{ISO,DC+}+U_{DC-,U2}/R_{ISO,DC-}.

Using the above equations, the two unknown insulation resistances R_{ISO,DC+} and R_{ISO,DC-} can be determined easily.

The determined insulation resistances can be compared, for example, with reference values in order to capture possible insulation faults (S6).

By continuous monitoring of the insulation resistances, advantageously already creeping insulation faults can be identified with the method according to the invention. The method can also be implemented quickly during operation by periodic, short-term changes in the bias to a level which is different than the normal operating level.

In the context of the invention, numerous modifications are possible. Thus, for example, the three-phase inverter 3 can be replaced by three single-phase inverters. It is also possible for a plurality of inverters to be connected in parallel with one another at the output side. In addition, different embodiments for the transformer 33, for example also with a delta connection, are also possible. The RF decoupling device 52 could also have LC filters constructed from one or more capacitances and inductances for blocking specific frequencies in the frequency band in which the high-frequency discharge currents and associated relevant harmonics are to be expected. The embodiments as shown in FIGS. 1 and 3, which are merely based on the inductances 53 and 54, 56, 57, are preferred owing to their simple implementation and high effectiveness, however. Advantageously, the RF decoupling device 52 according to the invention (if necessary with the bias generation device 43) can also be retrofitted in existing systems without any complexity. For this, the RF decoupling device 52 and the bias generation device 43 in a particularly preferred embodiment of the invention form a retrofittable additional module which can be integrated in existing photovoltaic systems.

What is disclosed is a photovoltaic system 1 for converting a DC voltage of a photovoltaic generator 2 into an AC voltage, which photovoltaic system 1 has a transformer-less inverter 3 with switch units with high-frequency clocking, wherein the DC voltage input 7 of said inverter 3 is connected to the photovoltaic generator 2 and a series circuit comprising a bias generation device 43 and an inductive RF decoupling device 52 is connected to the AC voltage output 8 of said inverter. The bias generation device 43 serves to apply a bias potential to the AC voltage output 8 of the inverter 3, by means of which the voltage potential at the DC voltage input 7 of the inverter 3 is also influenced indirectly. As a result, the potential at the photovoltaic generator 2 can be preset appropriately for the use of thin-layer photovoltaic modules or crystalline photovoltaic modules with contact-making of the cells on the reverse. The inductive RF decoupling device 52 serves the purpose of RF-decoupling the AC voltage side from the DC voltage side of the inverter 3 in order to avoid capacitive discharge currents at the photovoltaic generator 2 which are caused by the use of the bias generation device 43. A combination according to the invention of the bias generation device 43 and the inductive RF decoupling device 52 can be implemented with little complexity and retrofitted in existing systems.

1. An apparatus for converting an electrical DC voltage of a photovoltaic generator applied at the input side of the apparatus into an output-side AC voltage, comprising:
at least one transformer-less inverter, which has a DC voltage input for connecting a photovoltaic generator, and an AC voltage output;
a bias generation device for applying a bias potential at the AC voltage output of the inverter, as a result of which the voltage potential at the DC voltage input of the inverter is also influenced; and
an inductive RF decoupling device, which is designed for RF-decoupling the AC voltage side from the DC voltage side of the inverter.

2. The apparatus as claimed in claim 1, further comprising:
at least one photovoltaic generator having at least one photovoltaic module, which is either a thin-layer module or a crystalline photovoltaic module with photovoltaic cells with which contact is made on the reverse side.

3. The apparatus as claimed in claim 1, wherein the inverter is designed to have a three-phase configuration with three AC voltage output connections, which are each assigned to one of the three phases of its output voltage, and/or has a half-bridge configuration.

4. The apparatus as claimed in claim 1, wherein the inverter has a balancing circuit which is used to set the voltage potentials at input connections of the inverter to be substantially symmetrical with respect to the bias potential.

5. The apparatus as claimed in claim 4, wherein the balancing circuit comprises a DC voltage intermediate circuit which has two energy buffer stores, which are connected in series with one another between the input connections of the inverter, and comprises a neutral conductor, which is electrically connected to a node between the two energy buffer stores.

6. The apparatus as claimed in claim 1, further comprising:
a grid transformer, which is connected to the AC voltage output of the inverter and matches the inverter output voltage to grid characteristics of a grid to be fed.

7. The apparatus as claimed in claim 6, wherein the grid transformer has a primary side, which is connected to the AC voltage output of the inverter, a secondary side for connection to a grid and a neutral connection at the primary side, which neutral connection is preferably connected to a neutral conductor, which is passed through from the DC voltage side to the AC voltage side of the inverter.

8. The apparatus as claimed in claim 6, wherein the grid transformer is a three-phase transformer.

9. The apparatus as claimed in claim 1, wherein the bias generation device has a constant voltage source, which is connected between ground and the AC voltage output of the inverter.

10. The apparatus as claimed in claim 1, wherein the inductive RF decoupling device has an inductance, which is connected in series with the bias generation device in a branch between ground and a neutral conductor which is passed through from the DC voltage side to the AC voltage side of the inverter.

11. The apparatus as claimed in claim 10, wherein the neutral conductor is connected to a primary-side neutral connection of a grid transformer which is connected to the output of the inverter.

12. The apparatus as claimed in claim 1, wherein the inductive RF decoupling device has a number of inductances which corresponds to the number of phase-conducting output connections of the inverter, which inductances are each connected to an output connection and are, on the other hand, connected to a common node, wherein the bias generation device is connected between ground and the common node.

13. The apparatus as claimed in claim 1, further comprising:
a sensor device for capturing measurement parameters, including the DC voltage potentials at the input of the inverter and a current in a branch of the bias generation device, and
a control device, wherein
control device is designed to, on the basis of the captured measurement parameters, control the operation of the apparatus, identify possible fault states and respond to said fault states.

14. The apparatus as claimed in claim 13, wherein the control device is designed to variably adjust the magnitude of the bias applied by the bias generation device on the basis of the captured measurement parameters.

15. The apparatus as claimed in claim 13, wherein the control device has a logic for identifying ground faults or insulation faults by monitoring the current in the branch of the bias generation device, which logic includes a logic for identifying creeping insulation faults at the photovoltaic generator, said latter logic being designed
to actively modify and preset the potential of the bias of the bias generation device,
to measure the magnitude of the DC voltage potentials at the positive and negative input connections of the inverter and of the current in the branch of the bias generation device for two different preset bias potentials,
to determine, from the measured values and preset values for the voltage potentials and the currents, the insulation resistances at the positive and negative DC voltage input connections of the inverter, and
to compare said insulation resistances with reference values and, on the basis of the comparison, to identify the onset of an insulation fault.

16. An additional module for an apparatus for converting an electrical DC voltage of a photovoltaic generator applied at the input side of the apparatus into an output-side AC voltage, wherein
the apparatus has at least one transformer-less inverter with a DC voltage input for connecting a photovoltaic generator and an AC voltage output,
the additional module includes:
a connection means for connection to the AC voltage output of the inverter;
a bias generation device for applying a bias potential at the connection means, as a result of which the voltage potential at the DC voltage input of the inverter is also influenced when the connection means is connected to the AC voltage output of the inverter; and
an inductive RF decoupling device, which is designed for RF-decoupling the AC voltage side from the DC voltage side of the inverter when the connection means is connected to the AC voltage output of the inverter.
